(19) United States
(12) Patent Application Publication
(10) Pub. No.: US 2012/0307800 A1
(43) Pub. Date: Dec. 6, 2012

(54) Enhanced Single Voice Radio Call Continuity Using Packet Data Network Bi-Casting

(75) Inventors: Curt Wong, Sammamish, WA (US); Jari Mutikainen, Lepsama (FI); Mirko Schramm, Berlin (DE)

(73) Assignee: NOKIA CORPORATION, Espoo (FI)

(21) Appl. No.: 13/578,256

(22) PCT Filed: Feb. 14, 2011
(86) PCT No.: PCT/IB2011/050612

§ 371 Date: Aug. 10, 2012

Related U.S. Application Data
(60) Provisional application No. 61/304,041, filed on Feb. 12, 2010.

(51) Int. Cl. H04W 36/18

(52) U.S. Cl. 370/331

(57) ABSTRACT

A method can comprise providing single voice radio call continuity using packet data network bi-casting, wherein the call continuity is provided during a handover of a user equipment from a real-time transport protocol voice to a circuit switched voice call In such a method, the real-time transport protocol voice can be carried m a long term evolution system and the circuit switched voice call can be carried in a second or third generation system The method can be performed by a serving network of the user equipment.

### BACKGROUND

1. Field

Embodiments of the invention are directed to wireless or radio communications, and, more specifically, to improvements in the performance of single radio voice call continuity (SRVCC) in an effort to provide seamless SRVCC handling.

2. Description of the Related Art

There are a variety of techniques that can be used to attempt to ensure SRVCC. Most such solutions require the delay of sending of a handover command (HO CMD) to a user equipment (UE). This delay can impact coverage performance. As a result, to avoid loss of service, the handover may be triggered sooner than would otherwise be needed. Some solutions require bi-casting at the Internet Protocol (IP) Multimedia Subsystem (IMS), which means dependency on the home network, and some solutions need an S4-based Mobile Switching Center (MSC).

More specifically, the remote leg update may take a long time: for example, it may take anywhere from 100 ms to over a second, depending on the call scenario. The remote leg update means the time delay when the MSC server has initiated the IMS domain transfer towards the service centralization and continuity (SCC) application server (AS), until the remote end (UE or media gateway control function (MGCF)) has been updated for the new remote IP address (from MSC server/media gateway (MGW)). For this period of time, the remote end still sends media to the old IP address (i.e., to the local end UE directly over the IP access). On the other hand, the access transfer for the local end UE may be fast. It can take roughly 100 ms until the local end UE is ready to receive media via the new target access (i.e., circuit switched (CS) access via the MSC server). Thus, if the remote leg update takes any longer than the local end transfer (roughly 100 ms), for this period of time the local end user cannot hear the remote end user. This is viewed as an interruption in call continuity.

### SUMMARY

One embodiment is directed to a method. The method comprises receiving a downlink real-time transport protocol stream, and splitting the received downlink real-time transport protocol stream into a first and second copy. The method also comprises directing the first copy of the split stream to a user equipment and directing the second copy of the split stream to a media gateway, receiving an indication of completion of a session continuity procedure, and upon receipt of the indication, discontinuing sending the second copy of the split stream to the media gateway.

Another embodiment is directed to an apparatus. The apparatus comprises at least one processor, and at least one memory including computer program code. The at least one memory and the computer program code are configured, with the at least one processor, to cause the apparatus at least to receive a downlink real-time transport protocol stream, split the received downlink real-time transport protocol stream into a first and second copy, direct the first copy of the split stream to a user equipment and direct the second copy of the split stream to a media gateway, receive an indication of completion of a session continuity procedure, and upon receipt of the indication, discontinue sending the second copy of the split stream to the media gateway.

Another embodiment is directed to computer program embodied on a computer readable storage medium. The computer program is configured to control a processor to perform operations comprising receiving a downlink real-time transport protocol stream, splitting the received downlink real-time transport protocol stream into a first and second copy, directing the first copy of the split stream to a user equipment and directing the second copy of the split stream to a media gateway, and receiving an indication of completion of a session continuity procedure. Upon receipt of the indication, the sending of the second copy of the split stream to the media gateway is discontinued.

Another embodiment is directed to a method. The method comprises receiving a circuit switched voice signal, and performing circuit switched to real-time transfer protocol conversion on the received circuit switched voice signal while receiving a corresponding downlink real-time transfer protocol media stream. The method further comprises initiating sending of an uplink real-time transfer protocol media stream to a remote end, receiving an indication of completion of a session continuity procedure, and, upon receipt of the indication of the completion of the session continuity procedure, performing bi-directional communication with the remote end.

Another embodiment is directed to an apparatus. The apparatus comprises at least one processor, and at least one memory including computer program code. The at least one memory and the computer program code are configured, with the at least one processor, to cause the apparatus at least to receive a circuit switched voice signal, and perform circuit switched to real-time transfer protocol conversion on the received circuit switched voice signal while receiving a corresponding downlink real-time transfer protocol media stream. The at least one memory and the computer program code are further configured, with the at least one processor, to cause the apparatus to initiate sending of an uplink real-time transfer protocol media stream to a remote end, receive an indication of completion of a session continuity procedure, and upon receipt of the indication of the completion of the session continuity procedure, perform bi-directional communication with the remote end.

Another embodiment is directed to computer program embodied on a computer readable storage medium. The computer program is configured to control a processor to perform operations including receiving a circuit switched voice signal, and performing circuit switched to real-time transfer protocol conversion on the received circuit switched voice signal while receiving a corresponding downlink real-time transfer protocol media stream. The operations may further comprise initiating sending of an uplink real-time transfer protocol media stream to a remote end, receiving an indication of completion of a session continuity procedure, and, upon receipt of the indication of the completion of the session continuity procedure, performing bi-directional communication with the remote end.

### BRIEF DESCRIPTION OF THE DRAWINGS

For proper understanding of the invention, reference should be made to the accompanying drawings, wherein:

FIG. 1 illustrates a block diagram of a system according to one embodiment;

FIG. 2 illustrates a block diagram of a system according to another embodiment;

FIG. 3 illustrates a method according to one embodiment;

FIG. 4 illustrates a method according to another embodiment;

FIG. 5 illustrates a method according to another embodiment;

FIG. 6 illustrates a method according to another embodiment; and

FIG. 7 illustrates a block diagram of an apparatus according to an embodiment.

### DETAILED DESCRIPTION

According to certain embodiments of the invention, in the area of radio or wireless communications systems, the performance of single radio voice call continuity (SRVCC) is improved in an effort to provide seamless SRVCC handling. Particularly, in one embodiment, SRVCC procedures can be configured to minimize interruption in voice communication and/or call continuity.

By utilizing certain embodiments of the present invention, SRVCC can be ensured while delay due to the handover command (HO CMD) can be avoided. Additionally, the impact of the SRVCC mechanism can be isolated to a serving network.

More particularly, certain embodiments of the present invention separate the local and remote end switching completely, so the local end can perform the handover as soon as possible. Furthermore, such an enhancement can be localized to the serving network so it does not impose any new requirement to the remote-end (for example, the IMS).

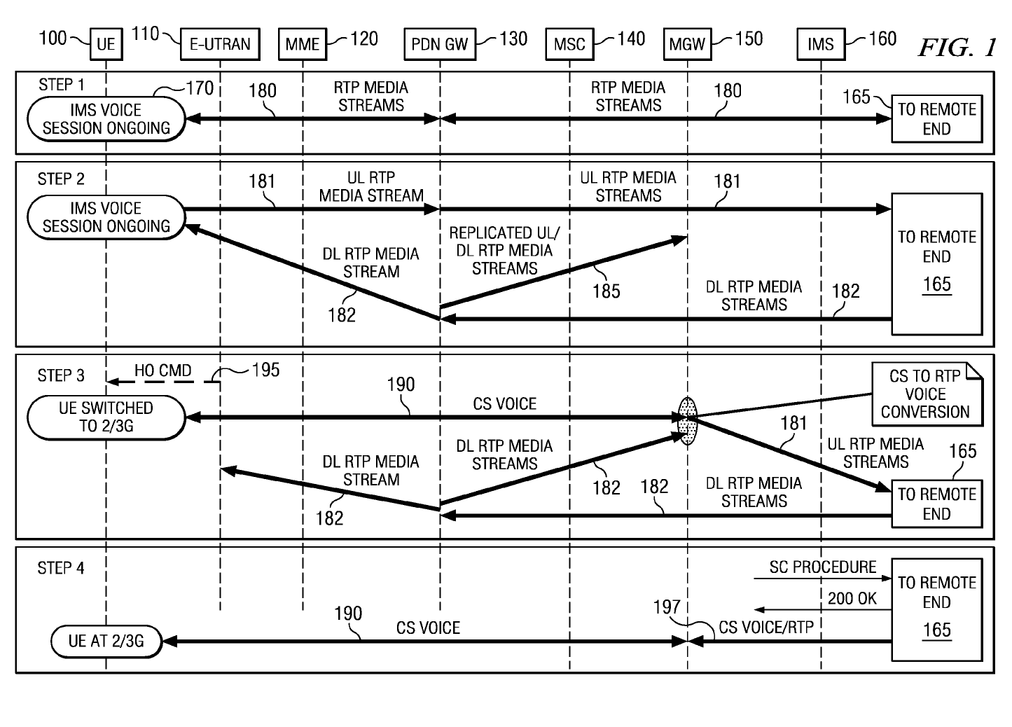

In order to allow seamless voice handling for SRVCC, the local end can prepare a bridging mechanism such that the switching of the real-time transport protocol (RTP) voice in long term evolution (LTE) to circuit switched (CS) voice over second or third generation (2/3G) is not noticeable at the remote end. FIG. 1 illustrates a block diagram of this embodiment from the media perspective.

In step 1 of FIG. 1, prior to SRVCC, an IMS voice call 170 over LTE is established with the remote end 165. The RTP media stream(s) 180 are delivered between the UE 100, packet data network gateway (PDN-GW) 130, and remote end 165.

In step 2 of FIG. 1, the evolved universal mobile telecommunication system (UMTS) Terrestrial Access Network (E-UTRAN) 110 triggers an SRVCC operation by requesting the mobility management entity (MME) 120 to perform an SRVCC to 2/3G access. The MME 120 then invokes the SRVCC MSC 140. During this MME-SRVCC MSC interaction, the PDN-GW 130 is instructed to replicate uplink (UL) and downlink (DL) RTP packet(s) 181, 182 to designated media gateway (MGW) 150 address/port numbers, thereby producing replicated UL/DL RTP packet(s) 185. This UL/DL RTP packet 185 is converted to CS voice in step 3 (discussed below) for connection to the 2/3G access.

As a result of certain embodiments, when the UE 100 is switched over the access to 2/3G, it can receive CS voice immediately on the downlink direction. The downlink (DL) RTP stream 182 from the remote end 165 is continuously sent to the PDN-GW 130; thus, no change is required on the remote end 165. The MGW 150 may require some conference bridge function as the first leg is connected to 2/3G access, the second leg is from the PDN-GW 130, and third leg is toward the IMS 160 for session continuity. The MGW 150 may use the LP address of the UE 100 towards the remote end 165 and not the LP address of the MGW 150.

In step 3 of FIG. 1, the UE 100 receives the handover command (HO CMD) 195 and is connected to 2/3G using CS voice 190. The DL CS voice is already connected at this point due to step 2 (discussed above). The UE 100 may start sending UL CS voice traffic to the MGW 150. The MGW 150 may then transcode this traffic to an UL RTP stream 181 and forward it to the remote end 165. In one embodiment, the MGW 150 can be made aware of the RTP stream codec being used based on IMS codec information received from MME 120. The UL sequence number and timestamp of the UL RTP stream 181 can be maintained toward the remote end 165 by the MGW 150. As the result of SRVCC, the PDN-GW 130 receives a request from MME 120 to deactivate the guaranteed bit rate (GBR) bearer related to voice, and provides a response to MME 120. The PDN-GW 130 starts a timer and continues to transmit the DL RTP streams 182 towards the MGW 150 until the timer expires. When the timer expires, the PDN-GW 130 completes the GBR bearer deactivation.

In step 4 of FIG. 1, the session continuity procedure is successfully executed in the remote end 165. Accordingly, the remote end 165 is sending CS voice 197 directly to the MGW 150. The CS to RTP stream transcoding resource and the PDN-GW 130 resources are released.

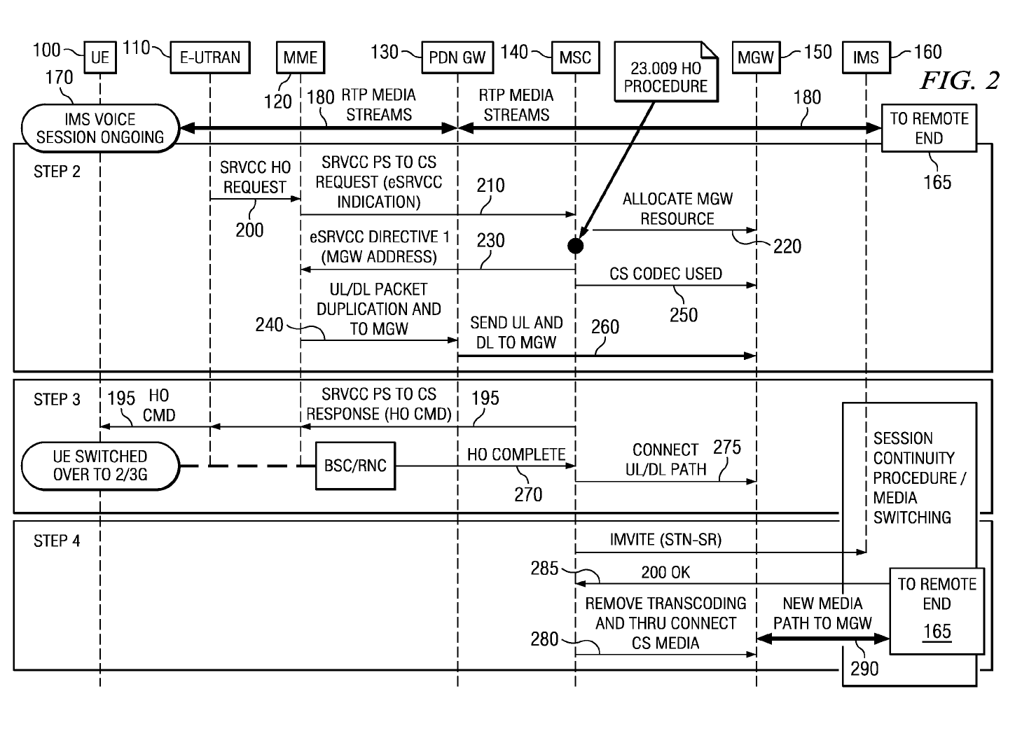

FIG. 2 illustrates a block diagram of PDN-GW bi-casting signaling plane handling, according to one embodiment of the invention. As illustrated in FIG. 2, in step 2 at 200, a SRVCC handover request is sent from E-UTRAN 110 to MME 120. At 210, MME 120 provides an indication to the SRVCC MSC 140 that the evolved packet core (EPC) supports enhanced SRVCC (eSRVCC) procedure, and also provides the IMS codec information as well as source IP address/port number and destination IP address/port number. MSC 140 allocates, at 220, designated MGW 150 resources to receive UL/DL RTP streams from PDN-GW 130. At 230, MSC 140 indicates to MME 120 the MGW 150 address to which those UL/DL RTP streams 180 are to be sent. At 240, MME 120 instructs PDN-GW 130 to replicate UL/DL RTP to MGW 150. MSC 140 instructs, at 250, MGW 150 to transcode DL RTP stream 182 to CS voice toward the 2/3G access. At 260, PDN-GW 130 sends UL and DL streams 181, 182 to MGW 150.

Step 3 of FIG. 2 comprises procedure(s) to connect UL CS traffic to RTP media stream 180. A DL RTP stream to CS traffic can be through-connected at step 2 (discussed above). This may allow the UE 100 to receive DL CS traffic immediately after switchover to 2/3G access. The UL CS traffic to RTP stream cut over is done when a handover complete indication 270 is received from 2/3G base station subsystem/radio network controller (BSS/RNC). In response to the handover complete indication 270, the UL/DL path is connected 275.

Step 4 of FIG. 2 comprises procedure(s), at 280, to release the RTP to CS transcoding resource and conferencing resources in MGW 150. The release is triggered when 200 OK message 285 is received by the SRVCC MSC 140. At 290, a new media path between remote end 165 and MGW 150 is formed.

There are also variants of the above embodiments that can be applied. For example, the procedure can skip the UL RTP stream redirection from PDN-GW 130 to MGW 150 when, for instance, it is assumed that the remote end's 165 UE 100 can recover from unexpected RTP's sequence number and timestamp when MGW 150 starts sending RIP UL media in step 3. Another possible variant is to have reception (Rx) interface coming from SRVCC MSC 140 to control the PDN-GW 130. This would allow the MSC 140 to instruct the PDN-GW 130 to redirect the UL/DL RTP to MGW 150. This solution may minimize the impact to bearer level signaling between MSC 140, MME 120, and PDN-GW 130.

One advantage of certain embodiments of the present invention is that the handover command (HO CMD) 195 is not delayed due to remote end switchover at the IMS 160. This absence of delay can help to maintain the principle that handover should be performed as soon as possible (that is to say, when local resources are ready).

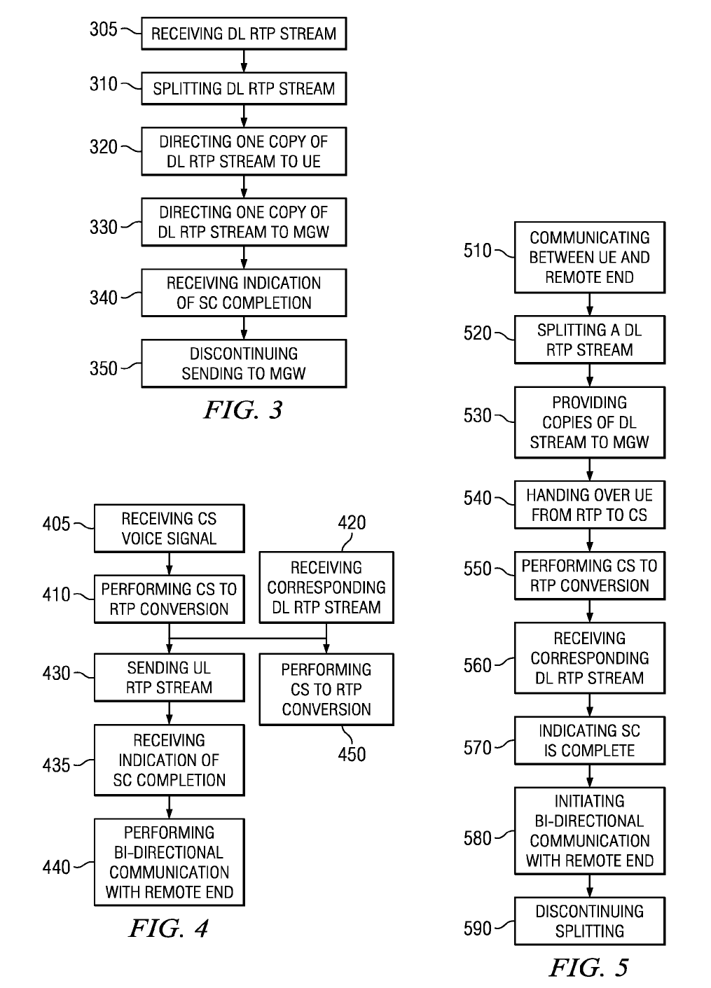

FIG. 3 illustrates a flow diagram of a method according to an embodiment of the present invention. The method of FIG. 3 can be performed, for example, by a PDN-GW. The method of FIG. 3 comprises, at 305, receiving a downlink (DL) real-time transport protocol (RTP) stream, and, at 310, splitting the received DL RTP stream. The method further comprises, at 320, directing one copy of the stream to a UE and, at 330, directing a second copy of the stream to a MGW. The method of FIG. 3 further comprises, at 340, receiving an indication of completion of a session continuity procedure and, upon receiving the indication, at 350, discontinuing the sending of the second copy of the stream to the MGW. The indication of completion can be a command from a MME to stop downlink packet duplication.

FIG. 4 illustrates a flow diagram of a method according to certain embodiments of the present invention. The method of FIG. 4 can be performed, for example, by a MGW. The method comprises, at 405, receiving a circuit switched voice signal. The method then comprises, at 410, performing circuit switched to real-time transfer protocol conversion on the received circuit switched voice signal while receiving, at 420, a corresponding downlink real-time transfer protocol media stream via a PDN-GW. The method also comprises, at 430, initiating the sending of an uplink real-time transfer protocol media stream to a remote end. The method further comprises, at 435, receiving an indication of completion of a session continuity procedure. Upon receipt of the indication of completion of the session continuity procedure, the method comprises, at 440, performing bi-directional communication with the remote end. The indication of completion may be, for example, a handover complete message from a RNC. The method may additionally comprise, at 450, performing real-time transfer protocol to circuit switched conversion on the received downlink real-time transfer protocol media stream.

FIG. 5 illustrates a flow diagram of a method according to certain embodiments of the present invention. The method of FIG. 5 can be performed, for example, by a serving network (including such devices as, but not limited to, a PDN-GW and a MGW) that serves a UE. The method comprises, at 510, communicating between the UE and a remote end using a RTP stream. The method also comprises, at 520, splitting, by a PDN-GW, a DL stream of the RTP stream and, at 530, providing a copy of the DL stream to a MGW. The method further comprises, at 540, handing over the UE from RTP to CS. The method additionally comprises, at 550, performing, by a MGW, CS to RTP conversion on a received CS voice signal while receiving, at 560, a corresponding DL RTP media stream via a PDN-GW. The method further comprises, at 570, receiving an indication of completion of a session continuity procedure. Upon receipt of an indication of completion of the session continuity procedure, the method comprises, at 580, initiating bi-directional communication between the MGW and the remote end and, at 590, discontinuing the splitting.

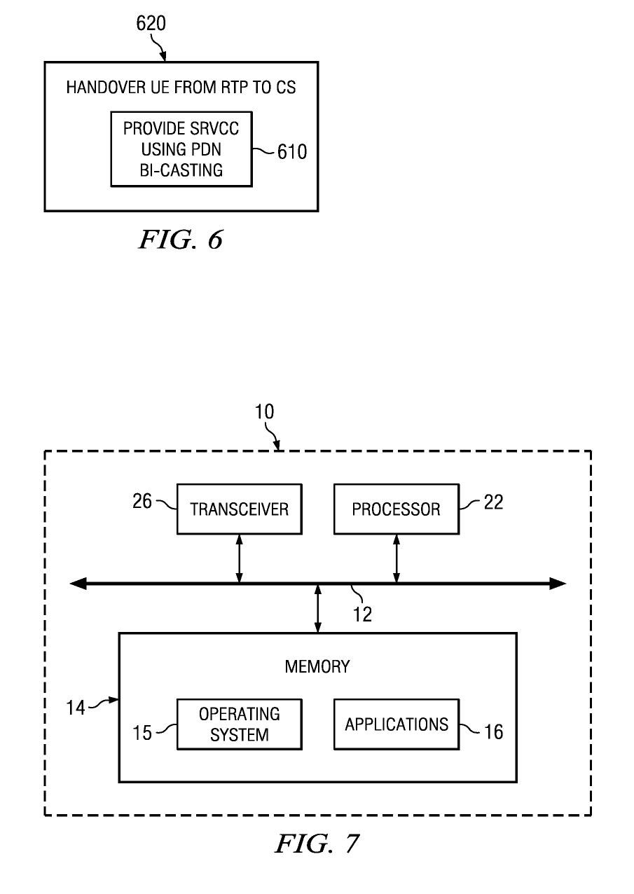

FIG. 6 illustrates a diagram of a method according to another embodiment of the present invention. The method comprises, at 620, providing SVRCC using packet data network bi-casting, whereby the call continuity is provided during a handover 620 of a UE from a RTP voice to a CS voice call. According to one embodiment, The RTP voice can be carried in a LTE system and the CS voice call can be carried in a 2/3G system.

According to certain embodiments, the methods described above may be stored as instructions on a computer readable storage medium and executed by a processor. The computer-readable medium may be a non-transitory medium that may be encoded with information that, when executed in hardware, performs a process corresponding to the processes disclosed in FIGS. 3-6, or any other process discussed herein. Examples of non-transitory media comprise a computer-readable medium, a computer distribution medium, a computer-readable storage medium, and a computer program product.

FIG. 7 illustrates a block diagram of an apparatus 10 according to certain embodiments of the present invention. In some embodiments, apparatus 10 can be variously embodied as a media gateway, PDN-GW, or other network element. It is noted that only the components or modules necessary for the understanding of the invention are illustrated in FIG. 7. However, it should be understood that apparatus 10 may comprise additional elements not illustrated in FIG. 7.

As illustrated in FIG. 7, apparatus 10 may comprise an interface 12, such as a bus or other communications mechanism, for communicating information between components of apparatus 10. Alternatively, the components of apparatus 10 may communicate directly with each other, without use of interface 12.

Apparatus 10 also comprises a processor 22, coupled to interface 12, for receiving, managing, and/or processing information, and for executing instructions or operations. Processor 22 may be any type of general or specific purpose processor, such as a central processing unit (CPU), one or more controllers, or an application specific integrated circuit (ASIC).

Apparatus 10 may further comprise a transceiver 26 for transmitting and receiving data to and from the network, or transmitting and receiving information to and from other devices on the communications network. Apparatus 10 further comprises memory 14 for storing information and instructions to be executed by processor 22. Memory 14 may be comprised of any combination of random access memory (RAM), read only memory (ROM), static storage such as a magnetic or optical disk, or any other type of machine or computer readable media. Computer readable media may be any available media that may be accessed by processor 22 and could comprise volatile or nonvolatile media, removable or non-removable media, and communication media. Communication media may comprise computer program code or instructions, data structures, program modules or other data, and comprises any information delivery media.

It should be noted that, although only one processor and one memory are illustrated in FIG. 7, more than one processor or memory may be included according to certain embodiments of the invention.

In one embodiment, memory 14 stores software modules or applications that provide functionality when executed by processor 22. The modules may comprise an operating system 15 that provides operating system functionality for apparatus 10. The memory 14 may also store applications 16.

According to certain embodiments, processor 22, along with memory 14 that stores computer program code, are configured to control apparatus 10 to receive a downlink real-time transport protocol stream, to split the received downlink real-time transport protocol stream, and to direct one copy of the stream to a UE and a second copy of the stream to a MGW. The memory 14 including the computer program code are also configured, with the processor 22, to cause the apparatus 10 to, receive an indication of completion of a session continuity procedure and, upon receipt of the indication of completion of the session continuity procedure, to discontinue sending the second copy of the stream to the media gateway.

In one embodiment, the indication of completion can be a command from a mobility management entity to stop downlink packet duplication. The apparatus 10 can comprise a PDN-GW.

In certain further embodiments, the memory 14 including the computer program code are configured, with the processor 22, to cause the apparatus 10 to perform circuit switched to real-time transfer protocol conversion on a received circuit switched voice signal while receiving a corresponding downlink real-time transfer protocol media stream via a packet data network gateway. The memory 14 including the computer program code may also be configured, with the processor 22, to cause the apparatus at least to initiate sending an UL RTP media stream to a remote end. The memory 14 including the computer program code may further be configured, with the processor 22, to cause the apparatus to receive an indication of completion of a session continuity procedure and, upon indication of the completion of the session continuity procedure, to initiate bi-directional communication with the remote end. In one embodiment, the indication of completion can be a handover complete message from a RNC.

In some embodiments, the memory 14 including the computer program code are also configured, with the processor 22, to cause the apparatus to perform RTP to CS conversion on a received DL RTP media stream. According to one embodiment, the apparatus 10 can comprise a MGW.

According to certain embodiments, when apparatus 10 of FIG. 7 is embodied as a PDN-GW, it can provide connectivity from the UE to external packet data networks. In other words, the PDN-GW can be the point of exit and entry of traffic for the UE. Although it is possible for a particular UE to have simultaneous connectivity with more than one PDN-GW so as to access multiple PDNs, the above discussion has been presented in the context of a single such connection. The PDN-GW can be configured to perform policy enforcement, packet filtering for each user, charging support, lawful interception, and packet screening. The PDN-GW can be embodied together with network elements in a single physical device or it can be a standalone device, such as a specially configured general purpose computer attached to a network.

According to some embodiments, when apparatus 10 of FIG. 7 is embodied as a MGW, it may be configured to be a translation device or server that converts digital media streams between disparate telecommunications networks such as public switched telephone network (PSTN), signaling system #7 (SS7), next generation networks, or private branch exchange (PBX). Thus, as a MGW, apparatus 10 may enable multimedia communications across next generation networks over multiple transport protocols such as asynchronous transfer mode (ATM) and Internet protocol (IP).

Media streaming functions and transcoding can also be performed in the MGW. A MGW can be a standalone device (such as, for example, a specially configured general purpose computer attached to a network). However, MGWs can be controlled by a separate (or co-located) MGW controller which can provide call control and signaling functionality. Some MGWs, such as those configured to employ the session initiation protocol (SIP), can be configured as stand-alone units with their own call and signaling control integrated (as opposed to having a separate MGW controller) and such MGWs can function as independent, intelligent SIP end-points.

In certain embodiments, a computer program is provided for implementing the functionality of the invention. The computer program is embodied on a computer-readable medium encoding instructions that, when executed in hardware, perform a process. The process comprises splitting a received downlink real-time transport protocol stream and directing one copy of the stream to a user equipment and a second copy of the stream to a media gateway. The process also comprises, upon indication of completion a of session continuity procedure, discontinuing sending the second copy of the stream to the media gateway. The indication of completion can be a command from a mobility management entity to stop downlink packet duplication. The hardware may comprise a PDN-GW.

The computer program, when executed, may further perform a process including performing circuit switched to real-time transfer protocol conversion on a received circuit switched voice signal while receiving a corresponding downlink real-time transfer protocol media stream via a packet data network gateway. The process also comprises initiating sending an uplink real-time transfer protocol media stream to a remote end. The process further comprises, upon indication of completion a of session continuity procedure, initiating bi-directional communication with the remote end. The indication of completion can be a handover complete message from a radio network controller.

In the preceding computer program, the process can further comprise performing real-time transfer protocol to circuit switched conversion on a received downlink real-time transfer protocol media stream. The hardware for executing the computer program may comprise a MGW.

The computer readable medium mentioned above may be at least partially embodied by a transmission line, a compact disk, digital-video disk, a magnetic tape, a Bernoulli drive, a magnetic disk, holographic disk or tape, flash memory, magnetoresistive memory, integrated circuits, or any other digital processing apparatus memory device.

It should be noted that many of the functional features described in this specification have been presented as modules, applications or the like, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be partially implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve its stated purpose.

Indeed, a module of executable code or algorithm could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

Therefore, one having ordinary skill in the art will readily understand that the invention as discussed above may be practiced with steps in a different order, may be practiced with hardware elements in configurations which are different than those which are disclosed, and that embodiments may be combined in any appropriate manner. Accordingly, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-20. (canceled)

21. A method, comprising:
receiving a downlink real-time transport protocol stream;
splitting the received downlink real-time transport protocol stream into a first and second copy;
directing the first copy of the split stream to a user equipment and directing the second copy of the split stream to a media gateway;
receiving an indication of completion of a session continuity procedure; and
upon receipt of the indication, discontinuing sending the second copy of the split stream to the media gateway.

22. The method according to claim 21, wherein the receiving of the indication of completion of the session continuity procedure comprises receiving a command from a mobility management entity to stop downlink packet duplication.

23. The method according to claim 21, wherein the method is performed by a packet data network gateway.

24. An apparatus, comprising:
at least one processor; and
at least one memory including computer program code,
the at least one memory and the computer program code are configured, with the at least one processor, to cause the apparatus at least to
receive a downlink real-time transport protocol stream;
split the received downlink real-time transport protocol stream into a first and second copy;
direct the first copy of the split stream to a user equipment and direct the second copy of the split stream to a media gateway;
receive an indication of completion of a session continuity procedure; and
upon receipt of the indication, discontinue sending the second copy of the split stream to the media gateway.

25. The apparatus according to claim 24, wherein the session continuity procedure comprises a command from a mobility management entity to stop downlink packet duplication.

26. The apparatus according to claim 24, wherein the apparatus comprises a packet data network gateway.

27. An apparatus, comprising:
at least one processor; and
at least one memory including computer program code,
the at least one memory and the computer program code are configured, with the at least one processor, to cause the apparatus at least to
receive a circuit switched voice signal;
perform circuit switched to real-time transfer protocol conversion on the received circuit switched voice signal, while receiving a corresponding downlink real-time transfer protocol media stream;
initiate sending of an uplink real-time transfer protocol media stream to a remote end;
receive an indication of completion of a session continuity procedure;
upon receipt of the indication of the completion of the session continuity procedure, perform bi-directional communication with the remote end.

28. The apparatus according to claim 27, wherein the indication of the completion of the session continuity procedure comprises a handover complete message from a radio network controller.

29. The apparatus according to claim 27, wherein the at least one memory and the computer program code are further configured, with the at least one processor, to cause the apparatus at least to
perform real-time transfer protocol to circuit switched conversion on the received downlink real-time transfer protocol media stream.

30. The apparatus according to claim 27, wherein the apparatus comprises a media gateway.

31. The apparatus according to claim 27, wherein the at least one memory and the computer program code are further configured, with the at least one processor, to cause the apparatus at least to
receive the corresponding downlink real-time transfer protocol media stream via a packet data network gateway.
